(19) United States
(12) Patent Application Publication
(10) Pub. No.: US 2012/0221388 A1
(43) Pub. Date: Aug. 30, 2012

(54) VALUE EXCHANGE OF CUSTOMER DATA

(75) Inventor: Erik Stephen Ross, Charlotte, NC (US)

(73) Assignee: BANK OF AMERICA CORPORATION, Charlotte, NC (US)

(21) Appl. No.: 13/035,528

(22) Filed: Feb. 25, 2011

(51) Int. Cl. G06Q 30/00; G06Q 40/00

(52) U.S. Cl. 705/14.17; 705/35; 705/14.25

(57) ABSTRACT

Embodiments of the invention are directed to methods and apparatuses for facilitating the value exchange of customer data. For example, one embodiment of the invention provides an online banking system that allows a customer to enter customer data, such as itemized transaction data or personal interest data, in return for incentives.

### BACKGROUND

Currently financial institutions have access to some, but not all of its customers' data. The customer data readily available to a financial institution can include biographical information such as an individual's address and marital status, account information such as types of accounts and balances of the accounts maintained with the financial institution, and, in some instances, transactional data including the time, location, and amount of a customer's purchases. To the extent allowed by privacy laws, financial institutions sometimes provide merchants with customer data so that the merchant can better understand consumer purchasing behavior and target marketing directly to the customer's preferences and needs.

In the current environment, financial institutions and merchants have limited avenues for identifying an individual's preferences and needs. The information that a financial institution generally has access to often does not provide the financial institution or merchants with complete information concerning a customer's interests, likes, dislikes, favorite stores, etc. Moreover, even the transactional data available to the financial institution does not always provide detailed information regarding the items purchased or the motivation for the purchase. For example, while the transactional data available to the financial institution may indicate the date, location, and cost of a recent purchase, the financial institution may not have access to an itemization of the goods purchased. Additionally, the transactional data will provide no indication as to whether the purchase constituted a gift, a replacement for an outdated item, a business expense, or an impulse buy. These limitations on the customer data currently available to financial institutions and merchants limit the ability of financial institutions and merchants to provide targeted marketing based on the preferences and needs of each individual. Consequently, individuals are subjected to large amounts of advertising and other marketing efforts for goods or services for which they have no interest.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention provide a system and method for gathering and monetizing customer data whereby a financial institution uses its unique relationship with customers and merchants to allow customers to monetize access to their data. For example, although many financial institutions currently have access to some information about their customers' transactions, such as the time, amount, and place of the transaction, the financial institutions usually do not have item-level knowledge about the actual items purchased in each transaction. Some embodiments of the invention allow the financial institution to gather this information (for potential marketing use by the institution or third parties) while letting the consenting customer profit from their own information. For example, one embodiment of the invention provides incentives, such as cash back, for each transaction that a customer makes if the customer enters item-level information about the transactions.

There may also be limitations on a financial institution's ability to disclose customer data it possesses to others outside of the financial institution. Federal and state privacy laws may place restrictions on what information can be disclosed to others without the consent of the customer. Therefore, another object of the present invention is to allow customers to identify a value for the right to disclose some or all of the customer data in the possession of the financial institution by accepting incentive offers presented by the financial institution.

In this regard, some embodiments of the invention provide a method that involves: (1) correlating customer data to an incentive, the customer data comprising information about customers of a financial institution; (2) offering the incentive to a customer of the financial institution when the customer is accessing the customer's account on a financial system; (3) receiving, via a computer, the customer input from the customer, wherein the customer input provides increased access to customer data about the customer; and (4) providing, via a computer, the incentive to the customer based on the receiving the customer input. In some embodiments of the invention the financial system is an online or mobile banking system and the method further includes offering the incentive, via a computer, to the customer of the financial institution when the customer is accessing the customer's account on the online or mobile banking system. In some embodiments of the invention, the incentive includes cash back, a lower interest rate, a credit applied to the customer's financial account, or a promotional offer (e.g., a coupon, discount, reward, etc.).

In some embodiments of the method, the customer input includes a customer consent that increases access by granting the financial institution greater rights to use the customer data. For example, the customer consent may increase access to customer data by granting the financial institution greater rights to disclose the customer data to third parties.

In other embodiments of the method, the customer input includes at least a portion of the customer data correlated to the incentive. For example, as described above, the customer input (and the customer data correlated to the incentive) includes item-level information about items purchased by the customer. In one such embodiment of the invention, the method further involves providing, via a computer, a list of customer transactions and a user interface that allows the customer to enter the item-level information for one or more of the customer transactions in the list. In some such embodiment, the incentive comprises a monetary amount for each customer transaction for which the customer provides item level information.

In some embodiments of the invention, the customer data correlated to the incentive includes personal interest information about the customer's personal interests. In some such embodiments, the method involves providing, via a computer, a user interface that prompts the user to enter the personal interest information.

In some embodiments of the method, correlating customer data to the incentive involves: assigning a value to the customer data; attributing an incentive to the customer data based on the value assigned to the customer data; and storing the incentive in a memory device as being associated with the customer data. In some such embodiments, assigning the value to the customer data involves: receiving a request (e.g., via a user interface) for specific customer data (e.g., a request from a third party via a user interface); reviewing the customer data currently in the possession of the financial institution; identifying at least a portion of the requested customer data not currently in the possession of the financial institution; and assigning the value to acquiring the portion of the requested customer data not currently in the possession of the financial institution.

In some embodiments of the invention, the method further involves analyzing the customer input to determine that it provides increased access to customer data about the customer. In some embodiments, the method also involves authenticating the identity of the customer and then receiving, via a computer, the customer input from the customer after the authenticating.

Embodiments of the invention also provide an apparatus where the apparatus has a memory device comprising information stored therein that correlates customer data to an incentive, the customer data comprising information about customers of a financial institution. The apparatus also includes a processor configured to: (1) offer the incentive to a customer of the financial institution when the customer is accessing the customer's financial account; (2) receive the customer input from the customer, wherein the customer input provides increased access to customer data about the customer; and (3) provide the incentive to the customer based on the receiving the customer input.

In some embodiments of the apparatus, the processor is further configured to provide, via a graphical user interface, a list of customer transactions and an interface that allows the customer to enter the item level information for one or more of the customer transactions in the list. In some such embodiments, the incentive is a monetary amount for each customer transaction for which the customer provides item level information. In some embodiments, the processor is configured to provide the incentive to the customer by crediting a financial account stored in the memory device.

In some embodiments of the apparatus, the customer data correlated to the incentive comprises personal interest information about the customer's personal interests. In some such embodiments, the processor is further configured to provide a graphical user interface that prompts the user to enter the personal interest information.

In some embodiments of the apparatus, the processor is further configured to: present a graphical user interface to a third party; and receive a request for the customer data from a third party via the graphical user interface. The processor may also be further configured to analyze the customer input to determine that it provides the increased access to customer data about the customer that correlates with the incentive.

Embodiments of the invention also provide a computer program product comprising a non-transitory computer-readable medium having computer-executable code stored thereon. In one embodiment, computer-executable code includes: a first code portion configured to correlate customer data to an incentive, the customer data comprising information about customers of a financial institution; a second code portion configured to offer the incentive to a customer of the financial institution when the customer is accessing the customer's financial account; a third code portion configured to receive the customer input from the customer, wherein the customer input provides increased access to customer data about the customer; and a fourth code portion configured to provide the incentive to the customer based on the receiving the customer input.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a flow diagram illustrating a process flow for facilitating the value exchange of customer data, in accordance with an embodiment of the present invention;

FIG. 2 provides a flow diagram illustrating a process flow for assigning a value to customer data to facilitate the value exchange of customer data, in accordance with an embodiment of the present invention;

FIG. 3 provides a flow diagram illustrating a process flow for collecting and analyzing customer data provided by the customer for facilitating the value exchange of customer data, in accordance with an embodiment of the present invention;

FIG. 4 provides a mixed block and flow diagram illustrating a system for facilitating the value exchange of customer data, in accordance with an embodiment of the present invention;

FIG. 5 provides a block diagram illustrating technical components of a system for facilitating the value exchange of customer data, in accordance with an embodiment of the present invention;

FIG. 6a illustrates an exemplary display page of a customer interface for collecting additional customer data, in accordance with an embodiment of the present invention;

FIG. 6b illustrates an exemplary display page of a customer interface for collecting additional customer data, in accordance with an embodiment of the present invention; and

FIG. 6c illustrates an exemplary display page of a customer interface for collecting additional customer data, in accordance with an embodiment of the present invention.

FIG. 6d illustrates an exemplary display page of a customer interface for collecting additional customer data, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Although many of the embodiments of the present invention described herein are generally described as involving a “financial institution,” other embodiments of the present invention may involve one or more persons, organizations, businesses, and/or other entities that take the place of, and/or work in conjunction with, the financial institution to implement one or more portions of one or more of the embodiments described and/or contemplated herein.

It will be understood that the term “customer data,” as used herein, generally refers to any information that relates to a customer and/or the customer's purchasing behavior. Such information includes, but is not limited to biographical information, such as age, sex, location etc.; account information, such as the type of financial account (e.g., checking, savings, investment etc.), balances, account activity, etc.; transactional information, such as date, location, amount of purchases, etc.; preferences, such as hobbies, interests, likes, dislikes, favorite stores, etc.; and behavioral information, such as activities, travel patterns, stores frequented, exercise habits etc.

It will also be understood that the term “incentives,” as used herein, generally refers to any positive motivational influence that encourages a customer to participate with the financial institution in the exchange of customer data. Incentives can include, but are not limited to, preferential rate offers, fee discounts, products, gift cards, discounts from participating merchants, entertainment offers like movie or concert tickets, coupons, cash, credit, etc.

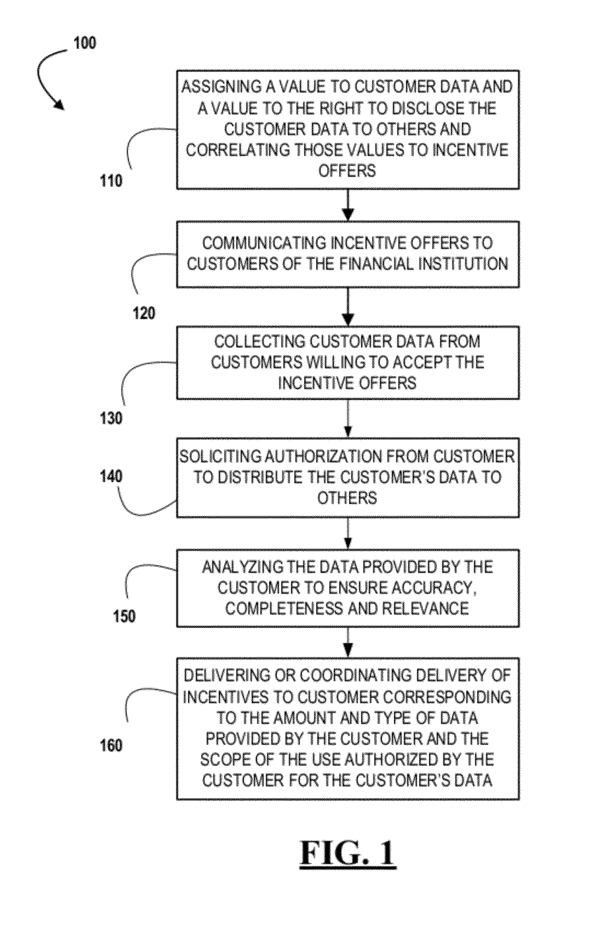

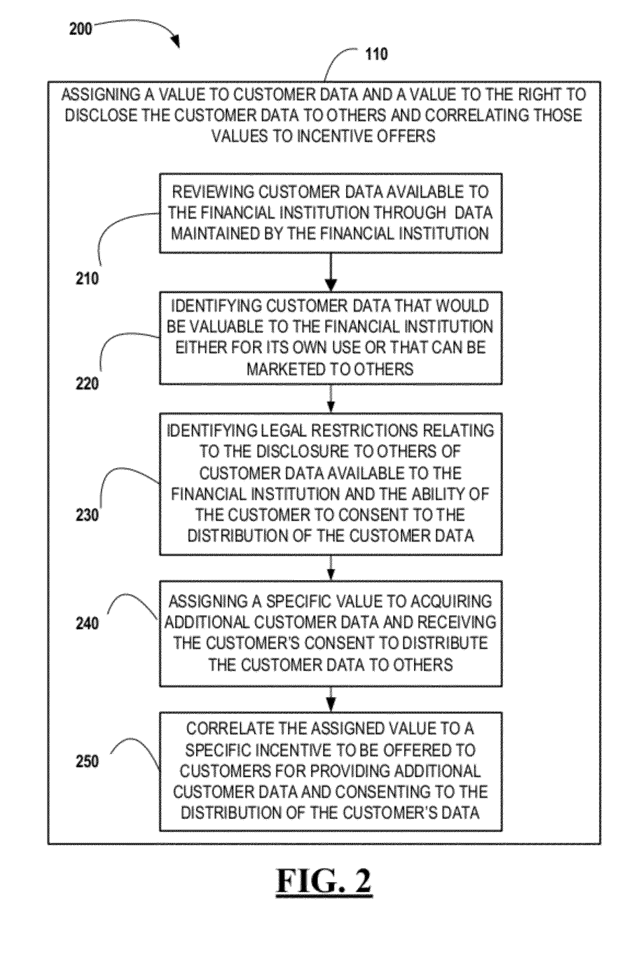

FIG. 1 illustrates a general process flow 100 for facilitating the value exchange of customer data, in accordance with an embodiment of the present invention. As represented by block 110, a financial institution assigns a value to customer data and/or to the right to disclose the customer data to others. The financial institution then correlates these values to incentive offers. As represented by block 120, the financial institution then communicates (e.g., via an online or mobile banking system) the incentive offers to customers of the financial institution. The financial institution then collects (e.g., via the online or mobile banking system) the customer data 130 of customers willing to accept an incentive offer in exchange for providing certain customer data. As represented in block 140, in one embodiment of the invention, the financial institution solicits (e.g., via the online or mobile banking system) a customer's authorization to distribute the customer's data to others. The financial institution then analyzes the data provided by the customer 150 to ensure the data is accurate, complete, and relevant to the request for customer data. If the information meets the requirements of the promotional offer, the financial institution delivers or coordinates the delivery of the incentive to the customer 160. Embodiments of the process 100, and systems for performing the process 100, are described in greater detail below with reference to FIGS. 2-6c.

For simplicity, it will be understood that the portion of the process flow represented by block 110 is sometimes referred to as the “value estimate.” In various embodiments of the invention the value estimate can be completed with different methods and apparatuses. FIG. 2 illustrates an exemplary flow 200 of a process for assigning a value to customer data to facilitate the value exchange of customer data, in accordance with an embodiment of the present invention.

As represented by block 210, the financial institution reviews the customer data available to the institution, such as biographical data, account data, and transactional data. In some embodiments, an associate uses a computer-based system that provides the associate with a view of the customer data that the financial institution currently has for a customer, average customer, or group of customers. In other embodiments, the process 200 is fully automated and is performed entirely by a computer system.

As represented by block 220, the financial institution then identifies customer data that is not currently available to the financial institution that may be of value to the financial institution either for its own use or for disclosing the data to others (e.g., merchants). In some embodiments of the invention, a computer system is used to communicate with merchants or others to identify the type of customer data desired by merchants or others.

As represented by block 230, the financial institution identifies legal restrictions relating to the use of customer data and/or the disclosure of customer data to others outside of the financial. The financial institution then determines the ability of the customer to consent to the financial institution's disclosure of its customer data to others. For example, a computer system may keep track of which customers have and have not given consent and then send incentive offers to those who have not consented or responded to a consent request.

As represented by block 240, the financial institution then assigns a value (e.g., a monetary value) to acquiring customer data not currently in the financial institution's possession and a monetary value to receiving the customer's consent to the disclosure of the customer's data to others. In some embodiments of the invention, the value is based on supply and demand for the specific type of customer data. The supply and demand may be determined by market research and surveys and/or automatically using a computer system that weighs different types of customer data differently and monitors a merchant marketplace for demand of different types of data. For example, some embodiments of the invention provide a merchant interface system where merchants request or bid on customer data. In such an embodiment, the merchant interface system can be used to determine demand for different types of data. In some embodiments of the invention, a customer can consent to different levels of disclosure for their personal data and, in such embodiments, different values may be placed on the different levels of disclosure. For example, the financial institution may pay the customer more to be able to provide a merchant with information about the customer along with the customer's name, as opposed to only being able to use the customer information generically.

As represented by block 250, the financial institution then correlates these values to incentives to be offered to customers in exchange for additional customer data and/or the customer's consent to the disclosure of the customer's data. In one embodiment of the invention, a computer system has the incentives stored in its memory and correlated therein with different types of customer data or disclosure consents.

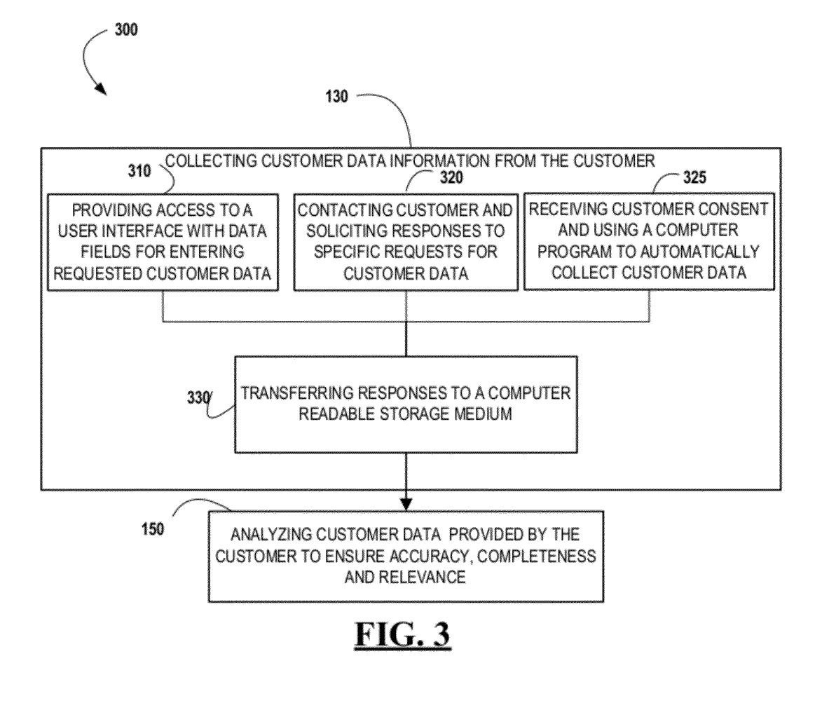

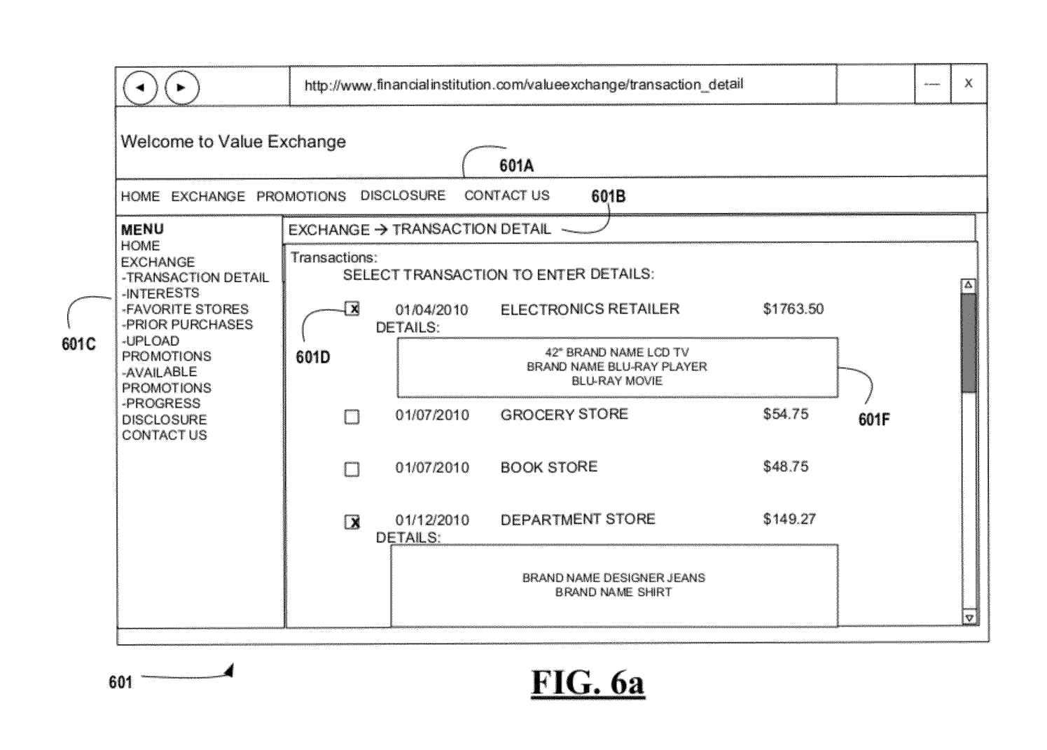

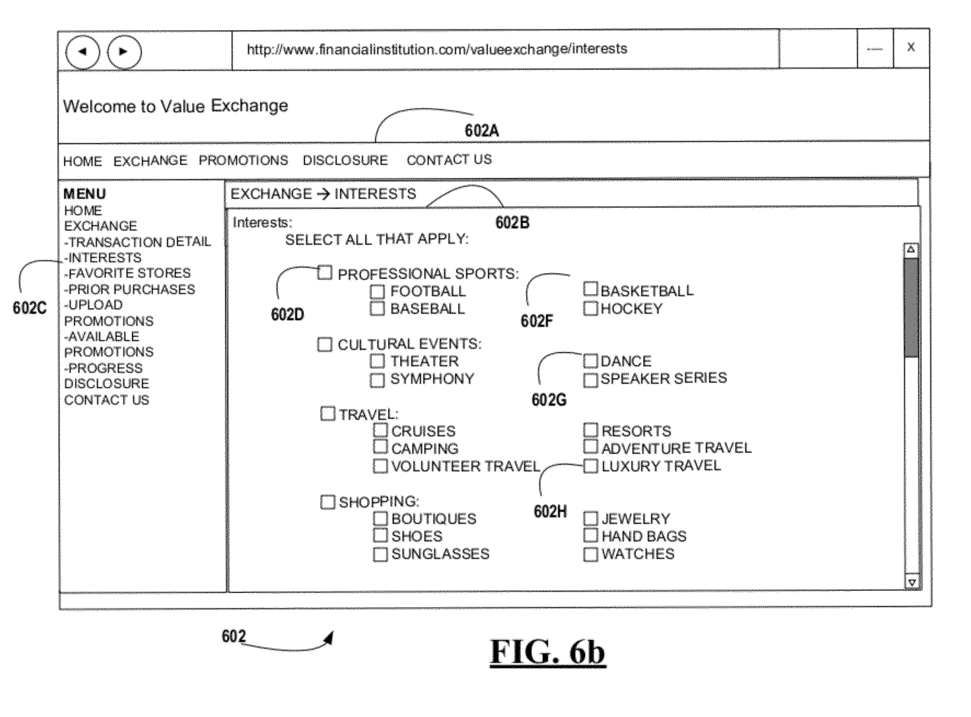

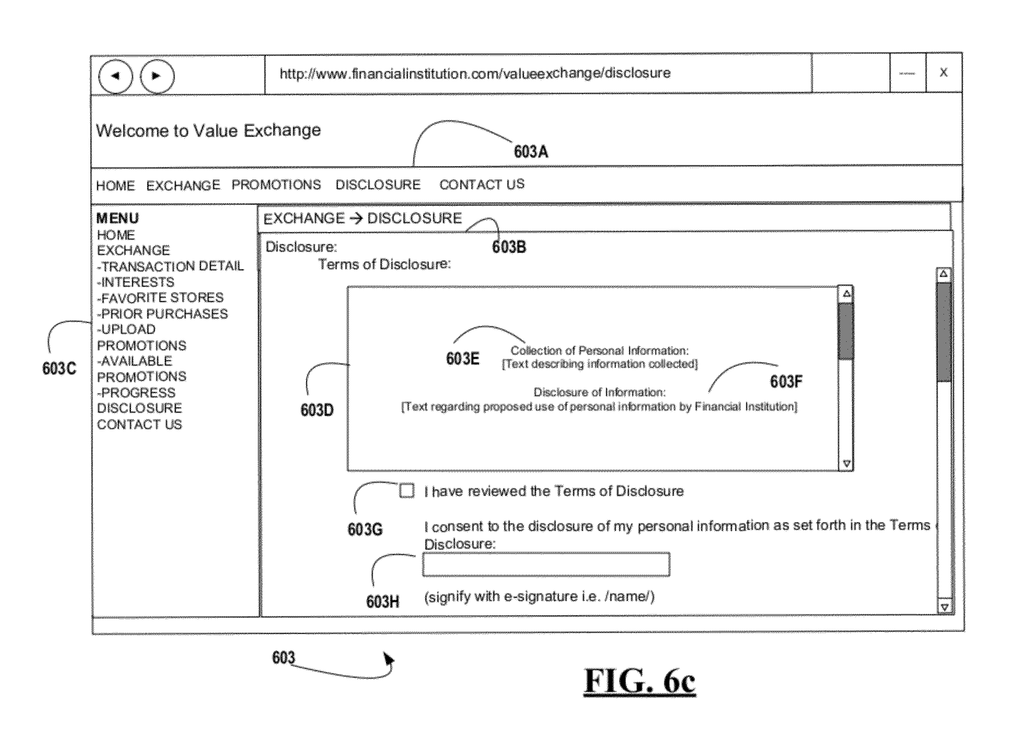

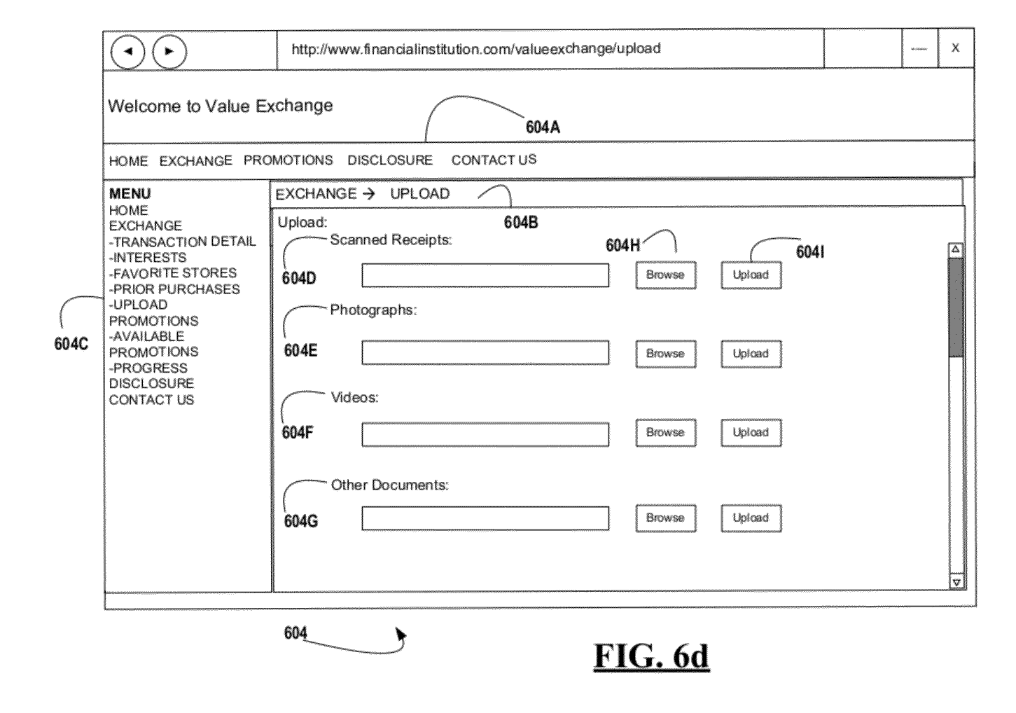

It will also be understood that the collection of the data from the customers (illustrated by block 130 of FIG. 1) can be embodied in a number of different apparatuses and systems. FIG. 3 provides a flow diagram 300 illustrating a general process flow of an apparatus for collecting and analyzing customer data provided by the customer for facilitating the value exchange of customer data, in accordance with embodiments of the present invention. In one embodiment of the invention, an apparatus 310 provides a customer with a user interface with data fields for entering the requested customer data. For example, some exemplary embodiments of a user interface are illustrated in FIGS. 6a-6c. In some embodiments of the invention, these user interfaces and data fields are part of an online or mobile banking system. For example, in an online banking system where the computer system authenticates a customer's identity and then provides the customer with a list of the customer's past financial transactions, the computer system may provide a button next to each transaction that, when activated by the customer, provides a data field for entering item-level information about the items purchased in the transaction (or other metadata/annotations about the transaction).

The customer input is recorded on a computer readable storage medium 330 and analyzed to ensure accuracy, completeness, and relevance, as shown in block 150. In a different embodiment of the invention, the customer data may be collected by directly contacting the customer and soliciting responses to specific requests for customer data 320. The data collected can then be transferred to a computer readable storage medium, as shown in block 330, so the customer data can be analyzed to ensure accuracy, completeness and relevance 150.

In a further embodiment of the invention the customer can opt to have the customer data automatically collected by a computer program 325. The computer program would collect customer data from sources authorized by the customer, such as, but not limited to, social networking activity, online purchasing and browsing activity, location information from a smartphone, the applications used on a personal computer or smartphone etc. The data automatically collected can then be transferred to a computer readable storage medium, as shown in block 330, so the customer data can be analyzed to ensure accuracy, completeness and relevance 150. It will be understood that in some embodiments of the invention the separate steps illustrated by FIG. 3 will be performed by a single system.

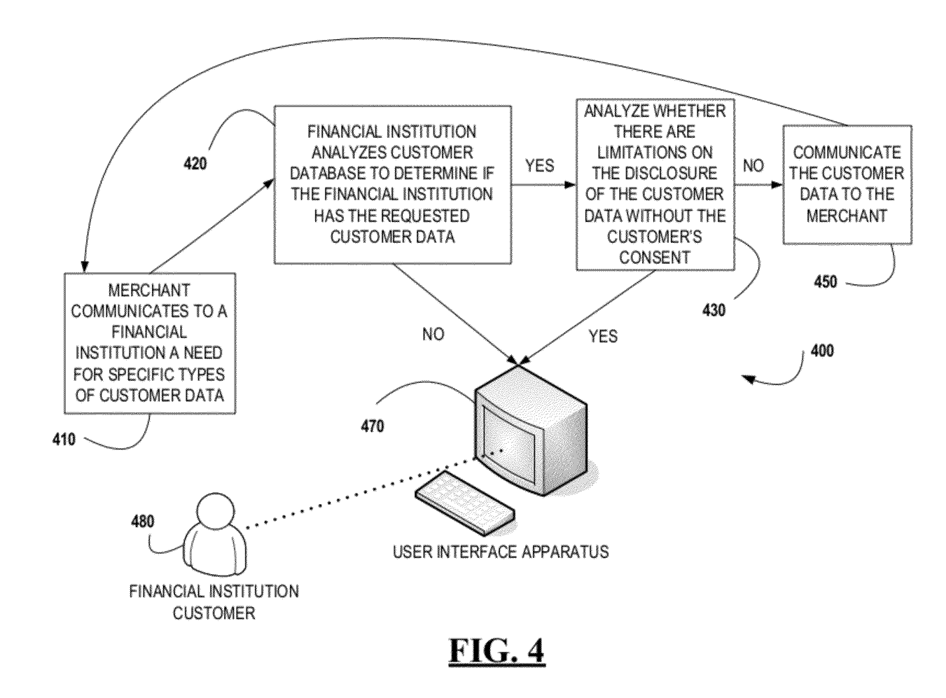

FIG. 4 provides a mixed block and flow diagram illustrating a system 400 for facilitating the value exchange of customer data, in accordance with an embodiment of the present invention. In some embodiments of this system a merchant that has a relationship with the financial institution communicates a need for a specific type of customer data 410. As shown in block 420 the financial institution analyzes its customer database to determine if the financial institution has the customer data requested by the merchant. If the financial institution does not have the specific customer data requested by the merchant, in some embodiments of the system, the financial institution employs a user interface apparatus 470 consistent with the apparatus illustrated by flow 100 to facilitate the exchange of the requested customer data. The user interface apparatus 470 assigns a value to the customer data 110, communicates incentive offers to customers 480 who are willing to provide the requested customer data 120, collects the customer data provided by the customer 130, analyzes the customer data provided 150 and delivers the incentives to the customer 480 earned by the data provided 160. In some embodiments of this system, if the financial institution has the customer data requested by the merchant, the financial institution will then analyze whether there are limitations on its ability to disclose the customer data without the customer's consent 430. If there are no limitations on the financial institution's ability to disclose the customer data, as shown in block 450 the financial institution can communicate the customer data to the merchant consistent with the institution's relationship with the merchant. If there are restrictions on the financial institution's ability to disclose the customer data without the customer's consent, then in some embodiments of this system the financial institution employs a user interface apparatus 470 consistent with the apparatus illustrated by flow 100 to facilitate a value exchange for the customer's consent to disclose the customer data. The user interface apparatus 470 assigns a value to receiving the customer's consent to the disclosure of the customer data 110, communicates incentive offers to customers 480 who are willing to provide the requested consent 120, collects the consent from the individual 140, analyzes the consent provided 150 and delivers the incentives earned by the customer 160.

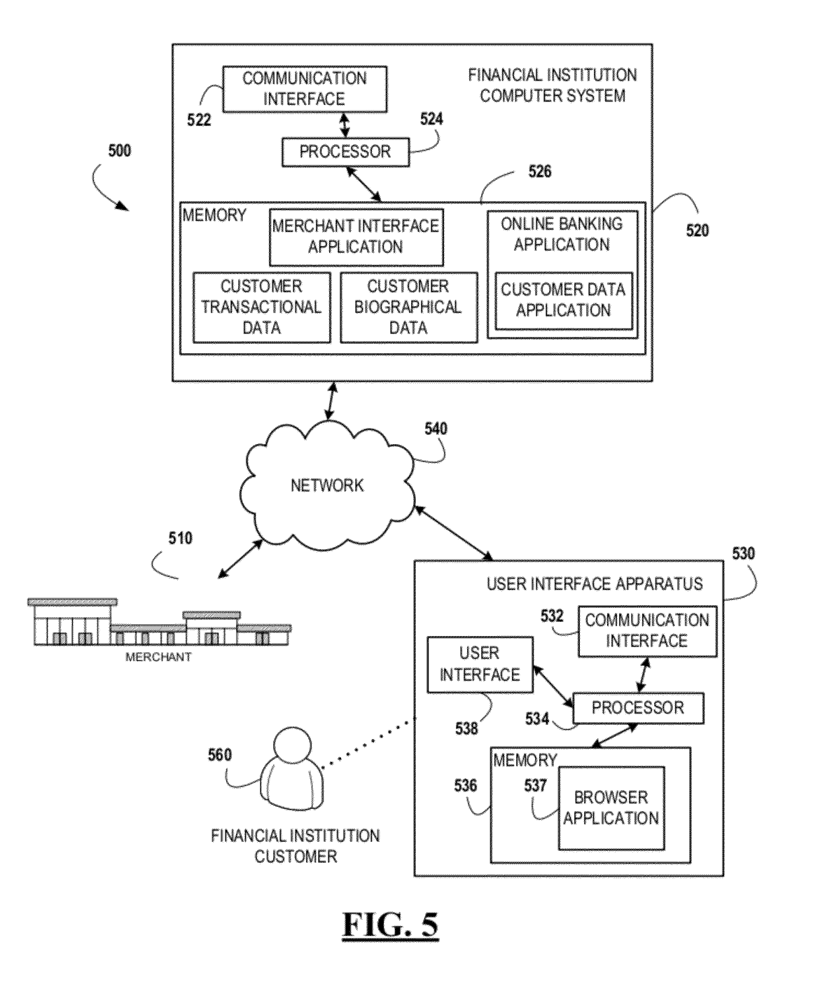

FIG. 5 provides a block diagram illustrating technical components for a system 500 for facilitating the value exchange of customer data, in accordance with an embodiment of the present invention. As illustrated, the system 500 includes a network 540, a user interface apparatus 530, and a financial institution computer system 520. FIG. 5 also illustrates a merchant 510 and financial institution customer 560. It will be understood that the financial institution customer 560 has access to the user interface 538. It will also be understood that the merchant 510 can communicate with the financial institution computer system 520.

In some embodiments, the merchant 510 may be operatively and selectively linked to a portion of the financial institution computer system 520 over the network 540. In other embodiments, the merchant 510 will make its requests for customer data directly to the financial institution. As illustrated, some embodiments of the financial institution computer system 520 include a merchant interface application configured to receive merchant requests for certain types of customer data and, in response, communicate customer data to the merchants.

As shown in FIG. 5, the user interface apparatus 530, financial institution computer system 520 and the merchant 510 are each operatively and selectively connected to the network 540, which may include one or more separate networks. In addition, the network 540 may include a local area network (LAN), a wide area network (WAN), and/or a global area network (GAN), such as the internet. It will also be understood that the network 540 may be secure and/or unsecure and may also include wireless and/or wireline technology.

The user interface apparatus 530 may include any computerized apparatus that can be configured to perform any one or more of the functions of the user interface apparatus 530 described and/or contemplated herein. In some embodiments, for example, the user interface apparatus 540 may include a personal computer system, a mobile phone, a personal digital assistant, smartphone, a public kiosk, a network device, and/or the like. As illustrated in FIG. 5, in accordance with some embodiments of the present invention, the user interface apparatus 540 includes a communication interface 532, a processor 534, a memory 536 having a browser application 537 stored therein, and a user interface 538. In such embodiments, the communication interface 532 is operatively and selectively connected to the processor 534, which is operatively and selectively connected to the user interface 538 and the memory 536.

In some embodiments, the user interface 538 will be user's computing device configured to access a secure website maintained by the financial institution. The financial institution customer 560 can then access the website using a login and password provided by the financial institution for authentication.

In some embodiments, the user interface 538 will be sensors, such as health sensors (e.g. heart rate monitors, pedometers, glucometers) or consumer product sensors, which are operatively and selectively connected to the processor 534 to automatically collect and record certain customer data.

Each communication interface described herein, including the communication interface 532 and 522, generally includes hardware, and, in some instances, software, that enables a portion of the system 500, such as the user interface apparatus 530 to transport, send, receive, and/or otherwise communicate information to and/or from the communication interface of one or more other portions of the system 500. For example, the communication interface 532 of the user interface apparatus 530 may include a modem, server, electrical connection, and/or other electronic device that operatively connects the user interface apparatus 530 to another electronic device, such as the electronic devices that make up the financial institution computer system 520.

Each processor described herein, including the processor 534 and 524, generally includes circuitry for implementing the audio, visual, and/or logic functions of that portion of the system 500. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the browser application 537 of the memory 536 of the user interface apparatus 530.

Each memory device described herein, including the memory 536 for storing the browser application 537 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 536 includes a browser application 537. In some embodiments of the invention the browser application 537 will be used to load and operate a secure website provided by the online banking application of the financial institution computer system 520. The online banking application includes a customer data application that runs a portion of the banking website that manages the collection of customer data from the customer 560. In some embodiments, the browser application 537 includes computer-executable program code portions for instructing the processor 534 to perform one or more of the functions of the browser application 537 described and/or contemplated herein. In some embodiments, the browser application 537 may include and/or use one or more network and/or system communication protocols.

Also shown in FIG. 5 is the user interface 538. In some embodiments, the user interface 538 includes one or more user output devices, such as a display and/or speaker, for presenting information to the financial institution customer 560. In some embodiments, the user interface 538 includes one or more user input devices, such as one or more buttons, keys, dials, levers, directional pads, joysticks, accelerometers, controllers, microphones, touch pads, touch screens, haptic interfaces, microphones, scanners, motion detectors, cameras, and/or the like for receiving information from the financial institution customer 560 and/or some other user. In some embodiments, the user interface 538 includes the input and display devices of a personal computer, such as a keyboard and monitor, that are operable to receive and display information associated with facilitating the value exchange of customer data.

It will be understood that the user interface apparatus 530 can be configured to implement one or more portions of the process flows described and/or contemplated herein. For example, in some embodiments, the user interface apparatus 530 is configured so that the communication interface 532 is operatively linked to the financial institution computer system 520 to receive the values assigned to the customer data and the right to disclose the customers data to others 110 and communicate incentive offers to customers 120 utilizing the communication interface 532, collecting the customer data 130 utilizing the user interface 538, solicit authorization from the customer to disclose the customer data to others 140 utilizing the user interface 538 and/or the communication interface 532, analyze the customer data provided 150 utilizing the memory 536 to store the customer data provided and the processor 534 to analyze the customer data, and deliver the incentives earned by the customer according the data and consent provided 160 using the user interface 538 and/or communication interface 532.

FIG. 5 also illustrates a financial institution computer system 520, in accordance with an embodiment of the present invention. The financial institution customer database 520 may include any computerized apparatus that can be configured to perform any one or more of the functions of the financial institution computer system 520 described and/or contemplated herein. In accordance with some embodiments, for example, the financial institution computer system 520 may include an engine, a platform, a server, a database system, a front end system, a back end system, a personal computer system, and/or the like. In some embodiments, such as the one illustrated in FIG. 5, the financial institution computer system 520 includes a communication interface 522, a processor 524 and a memory 526, which includes customer data such as customer transactional data and customer biographical data as illustrated in FIG. 5. The communication interface 522 is operatively and selectively connected to the processor 524, which is operatively and selectively connected to the memory 526.

It will be understood that the financial institution computer system 520 can be configured to implement one or more portions of the process flows described and/or contemplated herein. For example, in some embodiments, the financial institution computer system 520 is configured so that the communication interface 522 is communicatively linked to the merchant 510 to receive the merchant's request for customer data as shown in block 410 and implement some or all of the process flows 200 for assigning a value to customer data.

It will be understood that the embodiment illustrate in FIG. 5 is exemplary and that other embodiments may vary. For example, in some embodiments, some or all of the portions of the system 500 may be combined into single portion. Specifically, in some embodiments, the financial institution computer system 520 and the user interface apparatus 530 are combined into a single customer database and user interface apparatus configured to perform all of the same functions of those separate portions as described and/or contemplated herein. Likewise, in some embodiments, some or all of the portions of the system 500 may be separated into two or more distinct portions.

In addition, the various portions of the system 500 may be maintained for by the same or separate parties. For example, in some embodiments the financial institution computer system 520 and the user interface apparatus 530 may each be maintained by separate entities.

Referring now to FIGS. 6a-6d, a series of exemplary display pages 601-604 of the customer interface for collecting customer data are provided. In accordance with an embodiment of the present invention. It will be understood, that in some embodiments, each of the pages 601-604 is displayed on the same display that is operatively connected and/or otherwise associated with the user interface apparatus. In one embodiment, pages 601-604, and other similar pages, are displayed by the customer data application of the financial institution computer system 520 in the context of the financial institution's online or mobile banking environment.

It will also be understood that the display pages 601-604 are, in one embodiment, configured to navigate from the page 601 to the page 602, from the page 602 to the page 603, from the page 603 to the page 604 to the page 601 and/or vice versa. It will be further understood that the display pages 601-604 can be embodied as portions of a dashboard application, portions of a portal application, as intranet pages, as Internet web pages, and/or the like. In addition, it will be understood that, in some embodiments, the apparatus having the process flow 100, the apparatus having the process flow 200, the system having the process flow 300 (and/or one or more of the underlying apparatuses), the system 400 and/or the system 500 are configured to implement any one or more of the embodiments of the present invention described and/or contemplated herein in connection with the display pages 601-604.

Referring now to FIG. 6a, it will be understood that in some embodiments, the display page 601 is displayed after, or in response to an apparatus assigning a value to customer data and/or the right to disclose the customer data to others (e.g. the apparatus having the flow 100, the apparatus 420, financial institution customer database 520, etc.) and a customer has responded to the communication of an incentive offer by an apparatus (e.g. the apparatus of flow 100 or the user interface apparatus 530) and is prepared to offer additional customer data providing details regarding the transaction data already in the possession of the financial institution. Alternatively, the display page 601 is displayed after the customer navigates to the page from one of the other display pages 602, 603 or 604. As shown, in this embodiment, the display page 601 includes a menu bar 601A a location summary 601B a menu directory 601C a plurality of selectable check boxes such as 601D the customer's transaction data, such as 601E, and digital fields 601F that are available when a given check box like 601D is selected. In this embodiment, the menu bars, including 601A, location summaries, including 601B and menu directories, including 601C, shown on each display page 601-604 can all be used to navigate to various other display pages. In this embodiment, the customer uses display page 601 to select those transactions that the customer can, or is willing, to provide additional details regarding the purchase by actuating one of the selectable check boxes 601D and entering the additional details in the digital field 601F. Once the customer has entered all of the information relating to the transaction details that the customer is willing, or able, to provide, the customer can optionally navigate to one of the other display pages to provide alternative forms of customer data, view the incentives that are being offered and the customer's progress towards obtaining the incentive and/or contact the financial institution.

Referring now to FIG. 6b, the display page 602 includes a menu bar 602A a location summary 602B a menu directory 602C and a plurality of selectable check boxes such as 602E. It will be understood that in some embodiments of the invention, the display page 602 is displayed after, or in response to an apparatus assigning a value to customer data and/or the right to disclose the customer data to others (e.g. the apparatus having the flow 100, the apparatus 420, financial institution computer system 520, etc.) and a customer has responded to the communication of an incentive offer by an apparatus (e.g. the apparatus of flow 100 or the user interface apparatus 530) and is prepared to offer additional customer data providing details regarding the customer's interests. Alternatively, the display page 602 is displayed after the customer navigates to the page from one of the other display pages. In this embodiment, the customer uses display page 602 to provide information regarding the customer's interests by actuating one or more of the selectable check boxes 602E to acknowledge the customer's interest in the activity associated with the check box. So for example, in this embodiment, the customer has actuated the check boxes associated with dance 602G, luxury travel 602H and hockey 602F indicating the customer is interested in each of these activities. Once the customer has identified all of the activities in which the customer in interested the customer can optionally navigate to one of the other display pages to provide alternative forms of customer data, view the incentives that are being offered and the customer's progress towards obtaining the incentive and/or contact the financial institution.

Referring now to FIG. 6c, the display page 603 includes a menu bar 603A a location summary 603B a menu directory 603C a terms of disclosure text field 603D a selectable check box to indicate the customer has reviewed the Terms of Disclosure 603G and a digital field for inputting an electronic signature 603H. It will be understood that in some embodiments, the display page 603 is displayed after, or in response to an apparatus assigning a value to customer data and/or the right to disclose the customer data to others (e.g. the apparatus having the flow 100, the apparatus 420, financial institution computer system 520, etc.) and a customer has responded to the communication of an incentive offer by an apparatus (e.g. the apparatus of flow 100 or the user interface apparatus 530) and is prepared to provide consent to the disclosure of the customer's data to others. Alternatively, the display page 603 is displayed after the customer navigates to the page from one of the other display pages. In this embodiment, display page 603 provides a terms of disclosure field 603D which features text describing the nature and type of customer data that the financial institution has within its possession 603E and additional text describing what the financial institution intends to do with the customer's data if the customer provides consent to the disclosure of the customer's data to others 603F. In this embodiment, a selectable check box is actuated 603G by the customer to signify the customer has read the Terms of Disclosure contained in the terms of disclosure field 603D. The customer may then provide consent to the disclosure of the customer's data by entering an appropriate electronic signature within the digital field provided 603H. Once the customer has consented to the disclosure of the customer data, the customer can optionally navigate to one of the other display pages to provide alternative forms of customer data, view the incentives that are being offered and the customer's progress towards obtaining the incentive and/or contact the financial institution.

Referring now to FIG. 6d, the display page 604 includes a menu bar 604A a location summary 604B a menu directory 604C a plurality of data fields 604D-604G and a plurality of operative buttons such as 604H and 604I. It will be understood that in some embodiments of the invention, the display page 604 is displayed after, or in response to an apparatus assigning a value to customer data and/or the right to disclose the customer data to others (e.g. the apparatus having the flow 100, the apparatus 420, financial institution computer system 520, etc.) and a customer has responded to the communication of an incentive offer by an apparatus (e.g. the apparatus of flow 100 or the user interface apparatus 530) and is prepared to offer additional customer data by uploading various forms of customer data. Alternatively, the display page 604 is displayed after the customer navigates to the page from one of the other display pages. In this embodiment, the customer uses display page 604 to upload various forms of customer data, such as scanned receipts 604D, photographs 604E, videos 604F or other documents 604G. So for example, in one embodiment, the customer can upload scanned receipts for purchases made in cash by selecting the browse button 604H identifying the data file on a personal computer that correlates to the scanned receipts and uploading that data, for instance to the financial institution computer system 520 by actuating the upload button 604I. Similarly, a customer can upload photographs, videos or other documents, such as health records, gym contracts etc.) using the same steps and these photos, videos or documents can be analyzed by an apparatus having the system flow 150. Once the customer has uploaded all of the customer data the customer is interested in providing the customer can optionally navigate to one of the other display pages to provide alternative forms of customer data, view the incentives that are being offered and the customer's progress towards obtaining the incentive and/or contact the financial institution.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
correlating customer data to an incentive, the customer data comprising information about customers of a financial institution;
offering the incentive to a customer of the financial institution when the customer is accessing the customer's account on a financial system;
receiving, via a computer, the customer input from the customer, wherein the customer input provides increased access to customer data about the customer; and
providing, via a computer, the incentive to the customer based on the receiving the customer input.

2. The method of claim 1, wherein the financial system comprises an online banking system, and wherein the method further comprises:
offering the incentive, via a computer, to the customer of the financial institution when the customer is accessing the customer's account on the online banking system.

3. The method of claim 1, wherein the financial system comprises a mobile banking system, and wherein the method further comprises:
offering the incentive, via a computer, to the customer of the financial institution when the customer is accessing the customer's account on the mobile banking system.

4. The method of claim 1, wherein the customer input comprises a customer consent that increases access by granting the financial institution greater rights to use the customer data.

5. The method of claim 4, wherein the customer consent increases access by granting the financial institution greater rights to disclose the customer data to third parties.

6. The method of claim 1, wherein the customer input comprises at least a portion of the customer data correlated to the incentive.

7. The method of claim 6, wherein the customer data correlated to the incentive comprises:
item level information about items purchased by the customer.

8. The method of claim 7, further comprising:
providing, via a computer, a list of customer transactions and a user interface that allows a user to enter the item level information for one or more of the customer transactions in the list.

9. The method of claim 8, wherein the incentive comprises a monetary amount for each customer transaction for which the customer provides item level information.

10. The method of claim 6, wherein the customer data correlated to the incentive comprises personal interest information about the customer's personal interests, and wherein the method comprises:
providing, via a computer, a user interface that prompts the user to enter the personal interest information.

10. The method of claim 1, wherein the incentive comprises cash back.

11. The method of claim 1, wherein the incentive comprises a lower interest rate.

12. The method of claim 1, wherein the incentive comprises a promotional offer.

13. The method of claim 1, wherein correlating customer data to the incentive comprises:
assigning a value to the customer data;
attributing an incentive to the customer data based on the value assigned to the customer data; and
storing the incentive in a memory device as being associated with the customer data.

14. The method of claim 13, wherein assigning the value to the customer data comprises:
receiving a request for specific customer data;
reviewing the customer data currently in the possession of the financial institution;
identifying at least a portion of the requested customer data not currently in the possession of the financial institution; and
assigning the value to acquiring the portion of the requested customer data not currently in the possession of the financial institution.

15. The method of claim 1, further comprising:
receiving a request for the customer data from a third party via a computer interface.

16. The method of claim 1, further comprising:
analyzing the customer input to determine that it provides increased access to customer data about the customer.

17. The method of claim 1, further comprising:
authenticating the identity of the customer; and
receiving, via a computer, the customer input from the customer after the authenticating.

18. An apparatus comprising:
a memory device comprising information stored therein that correlates customer data to an incentive, the customer data comprising information about customers of a financial institution; and
a processor configured to:
offer the incentive to a customer of the financial institution when the customer is accessing the customer's financial account;
receive the customer input from the customer, wherein the customer input provides increased access to customer data about the customer; and
provide the incentive to the customer based on the receiving the customer input.

19. The apparatus of claim 18, wherein the customer input comprises a customer consent that increases access by granting the financial institution greater rights to use the customer data; and wherein the processor is configured to modify an indicator of use rights stored in the memory device.

20. The apparatus of claim 18, wherein the customer input comprises at least a portion of the customer data correlated to the incentive.

21. The apparatus of claim 18, wherein the processor is further configured to:
provide, via a graphical user interface, a list of customer transactions and an interface that allows the customer to enter the item level information for one or more of the customer transactions in the list.

22. The apparatus of claim 21, wherein the incentive comprises a monetary amount for each customer transaction for which the customer provides item level information.

23. The apparatus of claim 18, wherein the processor is configured to provide the incentive to the customer by crediting a financial account stored in the memory device.

24. The apparatus of claim 18, wherein the customer data correlated to the incentive comprises personal interest information about the customer's personal interests, and wherein the processor is further configured to:
provide a graphical user interface that prompts the user to enter the personal interest information.

25. The apparatus of claim 18, wherein the processor is further configured to:
present a graphical user interface to a third party; and
receive a request for the customer data from a third party via the graphical user interface.

26. The apparatus of claim 18, wherein the processor is further configured to:
analyze the customer input to determine that it provides the increased access to customer data about the customer that correlates with the incentive.

27. A computer program product comprising a non-transitory computer-readable medium having computer-executable code stored thereon, the computer-executable code comprising:
a first code portion configured to correlate customer data to an incentive, the customer data comprising information about customers of a financial institution;
a second code portion configured to offer the incentive to a customer of the financial institution when the customer is accessing the customer's financial account;
a third code portion configured to receive the customer input from the customer, wherein the customer input provides increased access to customer data about the customer; and
a fourth code portion configured to provide the incentive to the customer based on the receiving the customer input.

28. The computer program product of claim 27 comprising:
a code portion configured to output a list of customer transactions and an interface that allows the customer to enter the item level information for one or more of the customer transactions in the list.

29. The computer program product of claim 28 comprising:
a code portion that applies a monetary amount to the customer's financial account for each customer transaction for which the customer provides item level information.
